(19) United States
(12) Patent Application Publication
(10) Pub. No.: US 2015/0205478 A1
(43) Pub. Date: Jul. 23, 2015

(54) CONTENT LOCATION INTERFACE

(71) Applicants: Arnaud Claude WEBER, Saratoga, CA (US); John François Julien MELLOR, London (GB); Roma Rajni SHAH, San Francisco, CA (US); Alex Neely AINSLIE, San Francisco, CA (US)

(72) Inventors: Arnaud Claude WEBER, Saratoga, CA (US); John François Julien MELLOR, London (GB); Roma Rajni SHAH, San Francisco, CA (US); Alex Neely AINSLIE, San Francisco, CA (US)

(73) Assignee: GOOGLE INC., Mountain View, CA (US)

(21) Appl. No.: 13/357,585

(22) Filed: Jan. 24, 2012

Related U.S. Application Data
(60) Provisional application No. 61/569,752, filed on Dec. 12, 2011.

(51) Int. Cl. G06F 3/0488; G06F 3/0484

(52) U.S. Cl. CPC G06F 3/0488; G06F 3/04842

(57) ABSTRACT

Computer-implemented methods for finding text in a web page of a mobile web browser are provided. In one aspect, a method includes receiving input text to locate within a web page, identifying text in the web page matching the received input text, and providing for display, in a display bar, at least one indicator representing a location of the identified text within the web page. The method also includes receiving a selection of the at least one indicator in the display bar, and providing, for display, a portion of the web page that includes the matching text represented by the selected at least one indicator. Systems, graphical user interfaces, and machine-readable media are also provided.

### CROSS-REFERENCE TO RELATED APPLICATIONS

The present application claims the benefit of priority under 35 U.S.C. §119 from U.S. Provisional Patent Application Ser. No. 61/569,752 entitled “Content Location Interface,” filed on Dec. 12, 2011, the disclosure of which is hereby incorporated by reference in its entirety for all purposes.

### BACKGROUND

1. Field

The present disclosure generally relates to the presentation of data, and more particularly to the use of a computing device to locate portions of data.

2. Description of the Related Art

Mobile device web browsers have limited screen space with which to display a web page. When a user wants to search for text within that web page, the mobile web browser may highlight matching text for the portion of the web page that is currently displayed in the limited screen space. The user does not know, however, where, if anywhere, in the remaining portion of the web page there is additional matching text. The user must press a “next” button in the web browser in order to see any additional highlighted matching text.

### SUMMARY

According to one embodiment of the disclosure, a computer-implemented method for finding text in a web page of a mobile web browser is provided. The method includes receiving input text to locate within a web page, identifying text in the web page matching the received input text, and providing for display, in a display bar, at least one indicator representing a location of the identified text within the web page. The method also includes receiving a selection of the at least one indicator in the display bar, and providing, for display, a portion of the web page that includes the matching text represented by the selected at least one indicator.

According to another embodiment of the disclosure, a system for finding text in a web page of a mobile web browser is provided. The system includes a memory that includes instructions to locate text within a web page, and a processor. The processor is configured to execute the instructions to receive input text to locate within a web page, identify text in the web page matching the received input text, and provide for display, in a vertical display bar, at least one indicator representing a location of the identified text within the web page. The processor is also configured to execute the instructions to receive a selection of the at least one indicator in the vertical display bar, and provide, for display, a portion of the web page that includes the matching text represented by the selected at least one indicator.

According to a further embodiment of the disclosure, a mobile web browser for finding text in a displayed web page is provided. The mobile web browser includes a text input field configured to receive input text to locate within a web page, and a display bar configured to display at least one indicator representing a location of identified text within the web page matching the received input text. When a selection of the at least one indicator is received in the display bar, a portion of the web page that includes the matching text represented by the selected at least one indicator is displayed.

According to yet a further embodiment of the disclosure, a machine-readable storage medium includes machine-readable instructions for causing a processor to execute a method for finding text in a web page of a mobile web browser is provided. The method includes receiving input text to locate within a web page, identifying text in the web page matching the received input text, and providing for display, in a display bar, at least one indicator representing a location of the identified text within the web page. The method also includes receiving a touch input selecting the at least one indicator in the display bar, determining a zoom level at which to display a portion of the web page that includes the matching text represented by the selected at least one indicator, and providing, for display, the portion of the web page that includes the matching text represented by the selected at least one indicator by scrolling from a display of an initial portion of the web page to a display of the portion of the web page.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for a mobile web browser to receive content over a network, through which the user may then choose to search.

FIG. 2 is a block diagram illustrating the example client and server from the architecture of FIG. 1 according to certain aspects of the disclosure.

FIG. 3 illustrates an example process for finding text in a web page of a mobile web browser using an example client of FIG. 2.

FIGS. 4A and 4B are example interfaces associated with the example process of FIG. 3.

FIG. 5 is a block diagram illustrating an example computer system with which the client and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed mobile web browser provides a vertical display bar on the side of a web page that indicates, by marks within the display bar, the location of matching text in the web page. When a user presses a mark within the display bar, the web browser jumps to and displays the portion of the web page that includes the corresponding matching text. The portion of the web page that includes the matching text is optimally zoomed into by the web browser based on the size of the matching text, and the transition to the portion of the web page that includes the matching text can be animated. For example, the web browser can display scrolling from the currently displayed portion of the web page to the portion of the web page that includes the matching text while also simultaneously displaying zooming out of the currently displayed portion of the web page and then zooming in to the portion of the web page that includes the matching text.

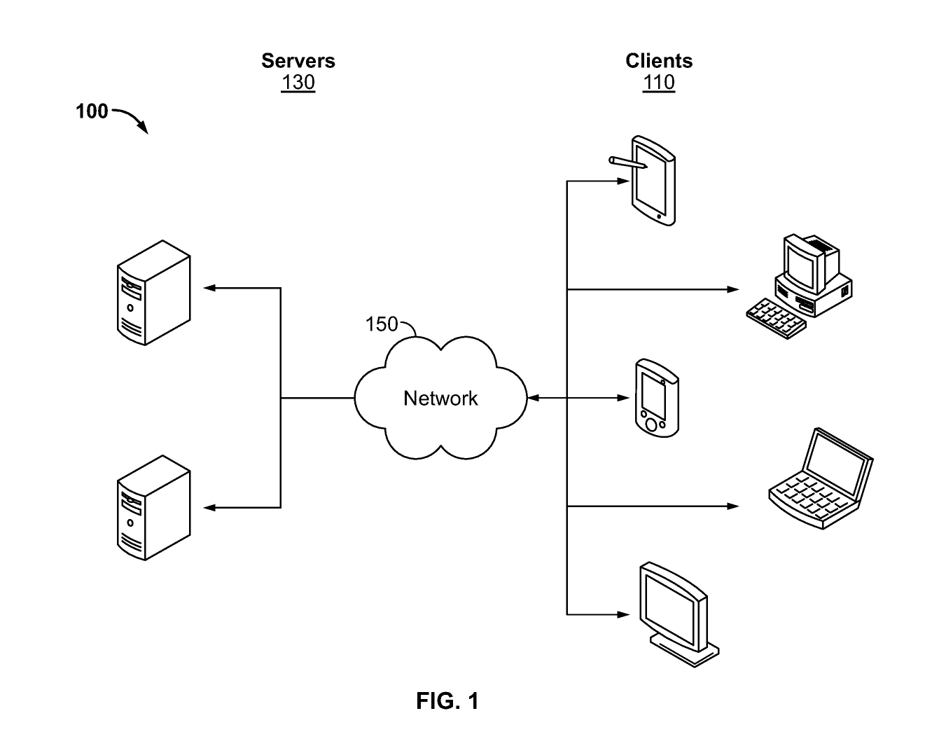

Turning to the drawings, FIG. 1 illustrates an example architecture 100 for a mobile web browser to receive content over a network, through which the user may then choose to search. The architecture 100 includes servers 130 and clients 110 connected over a network 150.

Each of the client 110 is configured to download, install, and run a web browser as disclosed herein. The web browser is configured to run on client 110 that are mobile or non-mobile. The clients 110 can be, for example, desktop computers, laptop computers, mobile devices (e.g., a smartphone, tablet computer, or PDA), set top boxes (e.g., for a television), video game consoles, or any other devices having appropriate processor, memory, and communications capabilities. In certain aspects, certain advantages of the web browser, such as the ability to respond to a touch input, may be more salient on clients 110, such as mobile devices, that have touch interfaces.

The web browser can be downloaded over the network 150 from one of the many servers 130. For purposes of load balancing, multiple servers 130 can also host the data for downloading the web browser. In certain instances, different versions and/or configurations of the web browser that include the features disclosed herein are available for download from a server 130 and subsequent installation depending on whether the client 110 is a mobile device or non-mobile device. The web browser, once installed on a client 110, is configured to load web pages from any one or multiple client servers 130 hosting the web pages. The servers 130 can be any device having an appropriate processor, memory, and communications capability for hosting the data for installing the web browser and for hosting the web pages. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The disclosed web browser, once downloaded from a server 130 and installed and executed on a client 110, is configured to display data. The data can be a downloaded web page, a locally generated web page, or other content, such as a text file. Although the examples discussed herein refer to a web page, any content that is viewable and searchable within the web browser is applicable to the disclosure. The disclosed web browser provides an input field with which a user can search for text within the web page. As the user inputs text into the input field, any text in the web page that matches the text in the input field is identified. The matching text in the web page is highlighted and their locations are identified in a display bar (e.g., scroll bar) within the web browser. When one of the locations is selected from the display bar, the corresponding portion of the web page with the matching text that corresponds to that location is displayed in the web browser. The web browser updates the identification of matching text in the web page based on any changes made to the text input by the user into the input field.

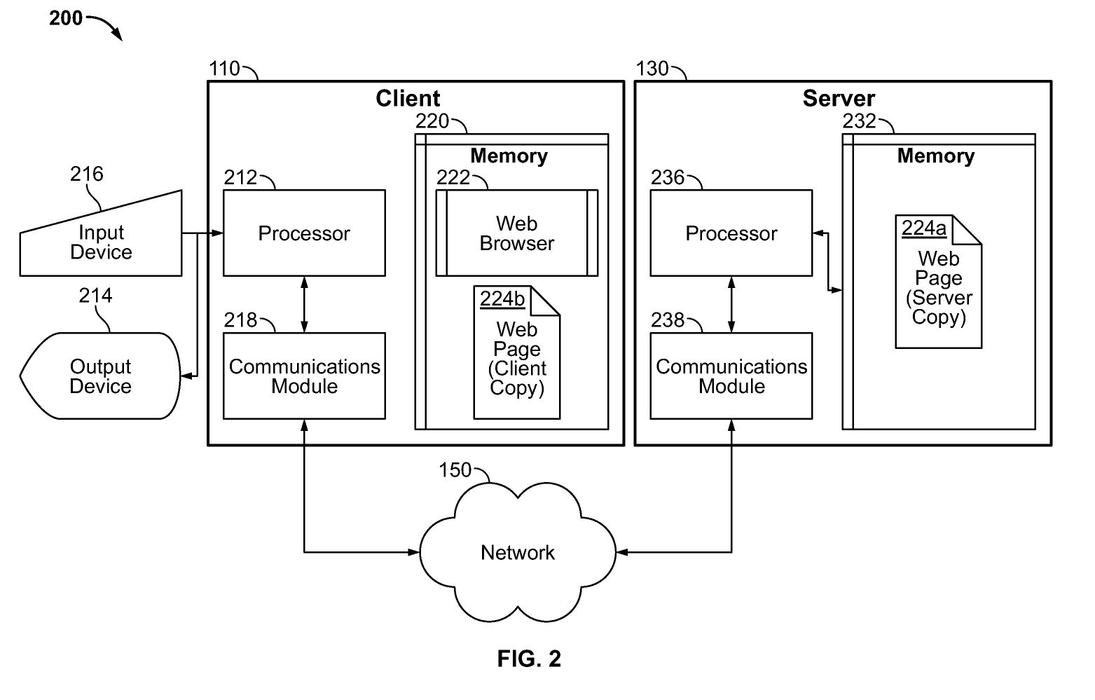

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The client 110 includes a processor 212, the communications module 218, and a memory 220 that includes a web browser 222 and a client copy of a web page 224b (or other displayable content) to display in the web browser 222 using the output device 214 (e.g., a display) of the client 110. In certain aspects, the web browser 222 is a mobile web browser configured for use with mobile devices, such as tablet computers and smartphones.

The client copy of the web page 224b is received from the server 130 over the network 150 using respective communications modules 218 and 238 of the client 110 and server 130. Specifically, the processor 236 of the server 130 provides a copy of a web page 224a from memory 232 to the client 110 in response to a request from the client 110. The client 110 also includes an input device 216, such as a keyboard, touchscreen, or mouse, to receive user text and selection inputs.

The processor 212 of the client 110 is configured to execute instructions, such as instructions physically coded into the processor 212, instructions received from software in memory 240, or a combination of both. For example, the processor 212 of the client 110 executes instructions from the web browser 222 to receive input text (e.g., from a user using input device 216, such as a keyboard) to locate within the web page 224b. The input text can be received in an input field displayed within the web browser 222 on the output device 214 in response to a request to input the text to locate in the web page 224b. The processor 212 also identifies text in the web page 224b matching the received input text. The processor 212 can highlight the identified text within the web page 224b (e.g., by changing the background of the text, drawing a border around the text, and/or changing the style of the text) when the text is displayed on the output device 214. The processor 212 is also configured to execute the instructions to provide, for display (e.g., on output device 214) in a display bar, at least one indicator representing a location of the identified text within the web page 224b. The display bar can be a vertical display bar or horizontal display bar, and the selection of displaying either can depend on, for example, whether the web browser 222 is viewed on the client 110 in a landscape mode or portrait mode, the shape and/or size of the web page 224, the direction of text within the web page 224b.

The processor 212 is further configured to receive a selection of an indicator in the display bar, and provide, for display (e.g., on output device 214), a portion of the web page 224b that includes the matching text represented by the selected indicator. The selection of the indicator in the display bar can be an automatic selection of the first instance of the identified text. For example, when text in the web page matching the received input text is identified by the processor 212, the first instance of the matching text in the web page 224b can automatically be displayed in the web browser 222 on the output device 214. The portion of the web page 224b that includes the matching text that is displayed in response to the selection can be provided for display by the processor 212 by scrolling from a display of an initial portion of the web page 224b to a display of the portion of the web page 224b that includes the matching text. The scrolling can be animated, such as by zooming out from the display of the initial portion of the web page 224b while scrolling and then zooming back in to the display of the portion of the web page 224b that includes the matching text.

In certain aspects, the processor 212 is configured to display the portion of the web page 224b that includes the matching text at a zoom level determined based on the size of the matching text. The zoom level can also be based on a predetermined minimum text size or on the source code (e.g., the size of an enclosing block of the Document Object Model of the web page 224b). For example, if the matching text is a long string of characters, then the zoom level can be set to ensure that the entire long string of characters is displayed together on the screen of the output device 214.

In certain aspects where the input device 216 is a touch input device, such as a touchscreen interface, the selection of the indicator in the display bar can be a touch input of the displayed indicator in the display bar. When the processor 212 receives a dragging motion of the touch input in a first direction of the display bar (e.g., downward along the display bar), the processor 212 provides, for display, another portion of the web page 224b in the first direction (from the previously displayed portion of the web page) that includes other matching text in response to the dragging motion. For example, the processor 212 will display a subsequent portion of the web page containing the matching text corresponding to the indicator in the display bar that is closest to the point currently touched by the user's finger. Similarly, during the same dragging motion, the processor 212 can receives a touch input in a second direction of the display bar (e.g., upward along the display bar), and the processor 212 provides, for display, yet another portion of the web page 224b in the second direction (from the previously displayed portion of the web page) that includes other matching text in response to the dragging motion.

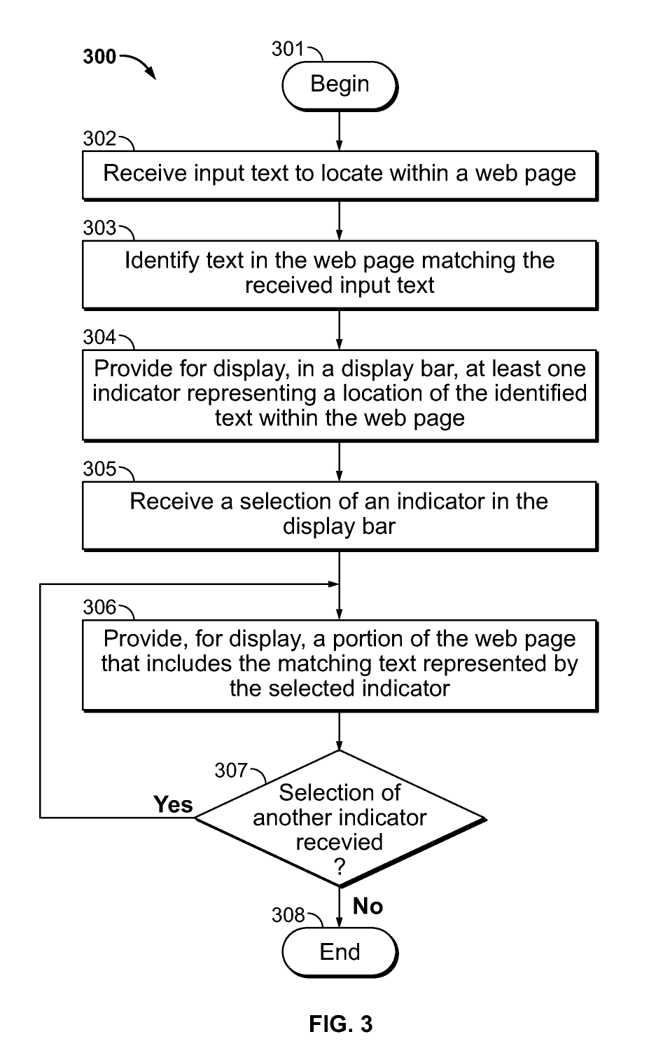

FIG. 3 illustrates an example process 300 for finding text in a web page of a mobile web browser 222 using the example client 110 of FIG. 2. The process 300 begins by proceeding from step 301 when a user loads a web browser 222 on the client 110, and the web browser 222 has a downloaded web page 224b available for display. Next, in step 302, input text to locate within a web page is received. In step 303, text in the web page matching the received input text is identified, and in step 304, at least one indicator representing a location of the identified text within the web page is provided for display in a display bar. In certain aspects, the portion of the web page that includes the first instance of matching text is automatically provided for display as part of step 304. In step 305, a selection of the indicator in the display bar is received, and in step 306, a portion of the web page that includes the matching text represented by the selected indicator is provided for display. If another indicator is selected in decision step 307, the process 300 returns to step 306, otherwise the process 300 ends in step 308.

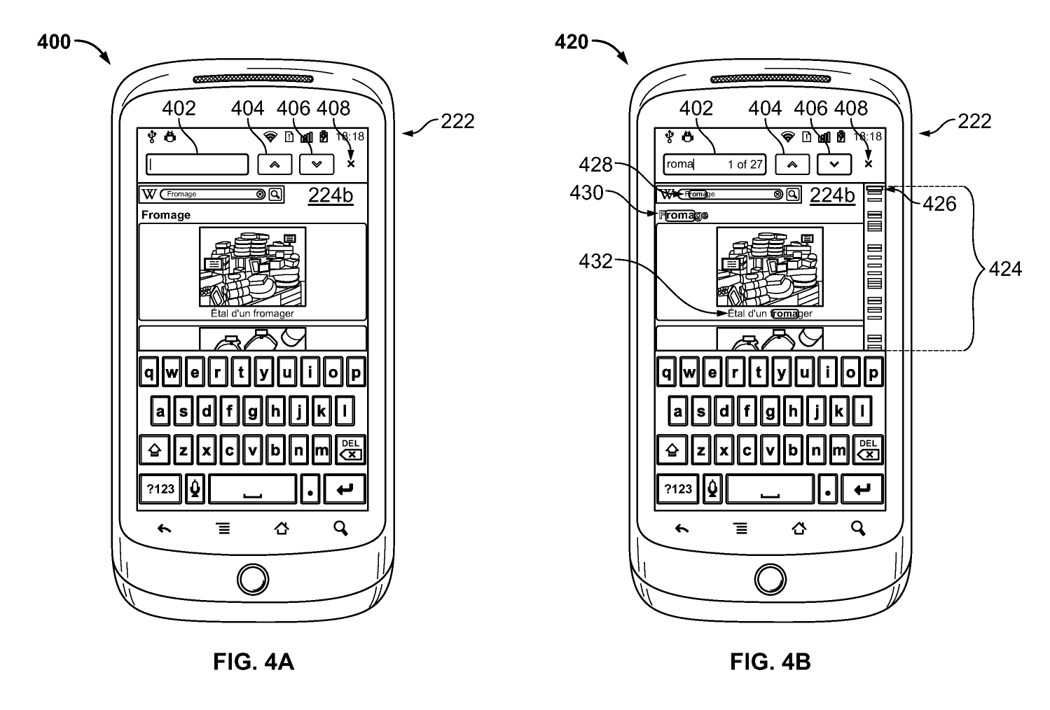

FIG. 3 sets forth an example process 300 for finding text in a web page of a mobile web browser 222 using the example client 110 of FIG. 2. An example will now be described using the example process 300 of FIG. 3, a smartphone as the client 110, and a search for the text “roma.” The process 300 begins by proceeding from step 301 when a user loads a web page 224b in a mobile web browser 222 on the user's smartphone 110 and presses a button on the smartphone's touchscreen interface 216 to find text in the web page 224b. The web browser 222 provides an input box for entry of the text to find, as illustrated in FIG. 4A. FIG. 4A is an example interface 400 of the web page 224b displayed in the mobile web browser 222. The mobile web browser 222 includes a text input field 402 for entering text to locate in the web page 224b, as well as forward and backward buttons 404 and 406 to identify a next occurrence of located text, and a close button 408 to hide the text input field 402 and forward and backward buttons 404 and 406.

In step 302, the user types the text “roma” into the input box, in step 303, text in the web page matching “roma” is identified, and in step 304, indicators representing the location of the text “roma” within the web page are provided for display in a display bar. FIG. 4B is an example interface 420 of the web browser 222 with highlighted instances 428, 430, and 432 of the text “roma” in the web page 224b and a display bar 424 identifying the locations of the text “roma” in the web page 224b. The display bar 424 is provided on the right side of the web browser 222 and includes many indicators of the locations of the text “roma” within the web page 224b, with each indicator distributed in the display bar 424 proportionately to the location of the corresponding matching text “roma” in the web page 224b. In other words, the location of each indicator is based on the horizontal position of the matching text, the vertical position of the matching text, and/or the order of the matching text in the source code (e.g., Document Object Model) of the web page. In step 305, the user touches the first indicator 426 in the display bar 424, and in step 306, the portion of the web page 224b that includes the matching text “roma” represented by the selected indicator is provided for display. As illustrated in FIG. 4B, the text “roma” corresponding to the first indicator 426 is displayed in the web page 224b. Another indicator from the display bar 424 is not selected, so the process 300 ends in step 308.

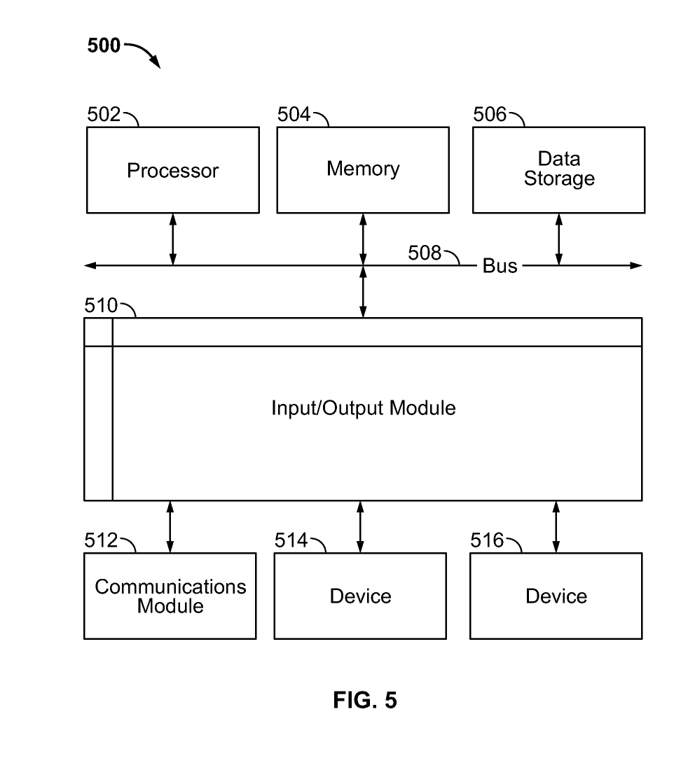

FIG. 5 is a block diagram illustrating an example computer system 500 with which the client 110 and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 (e.g., communications modules 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

1. A computer-implemented method for finding text in a web page of a mobile web browser, the method comprising:
receiving input text to locate within a web page;
identifying text in the web page matching the received input text;
providing for display, in a display bar, plural indicators representing respective locations of the identified text within the web page;
receiving touch input corresponding to a first indicator of the plural indicators in the display bar; and
providing, for display and in response the received touch input, a first portion of the web page that includes the matching text represented by the first indicator;
receiving a dragging motion associated with the touch input, wherein the dragging motion is in a first direction along the display bar;
identifying, in response to receiving the dragging motion in the first direction, a second indicator from among the plural indicators in the display bar that is closest to a current position of the touch input associated with the dragging motion in the first direction along the display bar; and
providing for display a second portion of the web page that includes the matching text represented by the identified second indicator.

2-3. (canceled)

4. The computer-implemented method of claim 1, further comprising determining a zoom level at which to display at least one of the first or second portion of the web page that includes the matching text represented by the respective first or second indicator based on a size of the matching text.

5. The computer-implemented method of claim 4, wherein determining the zoom level at which to display the portion of the web page is further based on a predetermined minimum text size.

6. (canceled)

7. The computer-implemented method of claim 1, wherein the display bar is a vertical display bar.

8. (canceled)

9. The computer-implemented method of claim 1, wherein the identified text is highlighted within the web page.

10. The computer-implemented method of claim 1, wherein the input text to locate is received by a mobile web browser configured for use with mobile devices.

11. The computer-implemented method of claim 1, further comprising:
receiving a request to input the text to locate in the web page; and
providing, for display, an input field in which to input the text,
wherein the received input text to locate in the web page is input into the input field.

12. A system for finding text in a web page of a mobile web browser, the system comprising:
a memory comprising instructions to locate text within a web page;
a processor configured to execute the instructions to:
receive input text to locate within a web page;
identify text in the web page matching the received input text;
provide for display, in a vertical display bar, plural indicators representing respective locations of the identified text within the web page;
receive touch input corresponding to a first indicator of the plural indicators in the vertical display bar; and
provide, for display and in response the received touch input, a first portion of the web page that includes the matching text represented by the first indicator;
receive a dragging motion associated with the touch input, wherein the dragging motion is in a first direction along the vertical display bar;
identify, in response to receiving the dragging motion in the first direction, a second indicator from among the plural indicators in the vertical display bar that is closest to a current position of the touch input associated with the dragging motion in the first direction along the vertical display bar; and
provide for display a second portion of the web page that includes the matching text represented by the identified second indicator.

13-14. (canceled)

15. The system of claim 12, wherein the processor is further configured to execute the instructions to determine a zoom level at which to display at least one of the first or second portion of the web page that includes the matching text represented by the respective first or second indicator based on a size of the matching text.

16. The system of claim 15, wherein the processor is further configured to determine the zoom level at which to display the portion of the web page based on a predetermined minimum text size.

17-18. (canceled)

19. The system of claim 12, wherein the processor is configured to provide highlighting for the identified text within the web page.

20. The system of claim 12, wherein the processor is configured to receive the input text to locate within a mobile web browser configured for use with mobile devices.

21. The system of claim 12, wherein the processor is further configured to execute the instructions to:
receive a request to input the text to locate in the web page; and
provide, for display, an input field in which to input the text,
wherein the received input text to locate in the web page is input into the input field.

22. A mobile web browser, operating on a computing device comprising a memory with instructions to locate text within a web page, and one or more processors configured to execute the instructions, the mobile web browser comprising:
a text input field configured to receive input text to locate within a web page; and
a display bar configured to display plural indicators representing respective locations of identified text within the web page matching the received input text,
wherein, when touch input corresponding to a first indicator of the plural indicators is received in the display bar, the one or more processors display a first portion of the web page that includes the matching text represented by the first indicator,
wherein, when a dragging motion associated with the touch input in a first direction along the display bar is received, one or more processors identify a second indicator from among the plural indicators in the display bar that is closest to a current position of the touch input associated with the dragging motion in the first direction along the display bar, and display a second portion of the web page that includes the matching text represented by the identified second indicator.

23. A non-transitory machine-readable storage medium comprising machine-readable instructions for causing a processor to execute a method for finding text in a web page of a mobile web browser, the method comprising:
receiving input text to locate within a web page;
identifying text in the web page matching the received input text;
providing for display, in a display bar, plural indicators representing respective locations of the identified text within the web page;
receiving touch input corresponding to a first indicator of the plural indicators in the display bar; and
providing, for display and in response the received touch input, a first portion of the web page that includes the matching text represented by the first indicator;
receiving a dragging motion associated with the touch input, wherein the dragging motion is in a first direction along the display bar;
identifying, in response to receiving the dragging motion in the first direction, a second indicator from among the plural indicators in the display bar that is closest to a current position of the touch input associated with the dragging motion in the first direction along the display bar; and
providing for display a second portion of the web page that includes the matching text represented by the identified second indicator.

24. The computer-implemented method of claim 1, further comprising determining a zoom level at which to display at least one of the first or second portion of the web page that includes the matching text represented by the respective first or second indicator based on a number of characters of the matching text.

25. The system of claim 12, wherein the processor is further configured to execute the instructions to determine a zoom level at which to display at least one of the first or second portion of the web page that includes the matching text represented by the respective first or second indicator based on a number of characters of the matching text.

26. The computer-implemented method of claim 1, further comprising:
providing, for display, a scrolling animation from a display of an initial portion of the web page to a display of the first portion of the web page that includes the matching text represented by the first indicator,
wherein the scrolling animation zooms out from the display of the initial portion of the web page and zooms into the display of the first portion of the web page that includes the matching text represented by the first indicator.

27. The system of claim 12, wherein the processor is further configured to execute the instructions to:
provide, for display, a scrolling animation from a display of an initial portion of the web page to a display of the first portion of the web page that includes the matching text represented by the first indicator,
wherein the scrolling animation zooms out from the display of the initial portion of the web page and zooms into the display of the first portion of the web page that includes the matching text represented by the first indicator.

28. The computer-implemented method of claim 1, wherein the dragging motion is in a first direction along the display bar followed by a second direction opposite the first direction along the display bar, the method further comprising:
identifying, in response to receiving the dragging motion in the second direction, a third indicator from among the plural indicators in the display bar that is closest to an updated position of the touch input associated with the dragging motion in the second direction; and
providing for display a third portion of the web page that includes the matching text represented by the identified third indicator.
